(19) United States
(12) Patent Application Publication
(10) Pub. No.: US 2025/0169612 A1
(43) Pub. Date: May 29, 2025

(54) ADJUSTABLE BED

(71) Applicant: Wayne E. PATTISON, Portage, MI (US)

(72) Inventor: Wayne E. PATTISON, Portage, MI (US)

(21) Appl. No.: 18/522,542

(22) Filed: Nov. 29, 2023

(51) Int. Cl. A47C 19/02; A47C 20/04

(52) U.S. Cl. CPC A47C 19/025; A47C 20/04

(57) ABSTRACT

A bed frame with various adjustable sections is provided. The structure of the bed frame is such that it is fully useful in tight spaces.

### BACKGROUND AND SUMMARY

This invention relates generally to beds and more particularly to powered adjustable beds. Adjustable beds have been used to permit the user to adjust the head and foot sections of the bed to different positions. While originally only manually adjustable, some beds have head and foot sections that are movable by motors operated by the user sometimes via a remote control.

Adjustable beds were originally designed principally for use in medical environments by patients who had to spend long periods of time in bed in a medical facility or at home if they were bed-ridden. However, more recently, adjustable beds are also being used in residential environments by users who have no health or physical impairment. An increasing number of people place televisions and other media-based entertainment devices in the bedroom, and more time is spent lounging in bed. Hence, the bed, and in particular an adjustable bed, is considered by many users an alternative piece of leisure furniture.

A typical bed includes a base and a mattress frame or support which is divided into multiple sections. The sections are moveable from a flat, resting position to a seated position with the legs bent or the legs straight. The sections are movable by motor drives, hand operated cranks or through the patient's weight. The adjustable bed may have at least one actuator to position the adjustable bed sections. There may be more than one actuator for each adjustable section.

Also, as many people travel and stay in recreational vehicles (RVs), modern conveniences and comforts are desired in such a setting. However, space is such an environment is limited, and thus presents challenges as to space and maneuverability.

Thus, there is a desire for a bed which is simpler in construction and less expensive while being adjustable and easy to use.

One embodiment of the present invention includes an adjustable bed frame comprising a base, a slide rail connected to the base, a first frame section, a second frame section and a third frame section. The base has a first side member and a second side member. The first frame section includes at least one cross bar, and the second frame section is pivotally attached to the first frame section and has a head end edge, a first bar member, and a second bar member opposed to the first bar member. The third frame section is pivotally attached to the first frame section and includes a third bar member and a fourth bar member opposed to the third bar member. The cross bar is slidably engaged with the slide rail, the second frame section being adjustable from a first position to a second position such that the angle of the first bar member with respect to the first side member and the angle of the second bar member with respect to the second side member are adjustable while the head end edge remains substantially disposed in a single vertical plane in the first position and in the second position.

Another embodiment of the present invention includes an adjustable bed frame comprising a base having a first side member and a second side member. A first slide rail is connected to the first side member of the base, and a second slide rail is connected to the second side member of the base. A first frame section includes a first bar with a first end edge, a second bar with a second end edge, a third bar, and a fourth bar, the first bar and the second bar being parallel to each other and the third bar and the fourth bar being parallel to each other. The first bar is pivotally attached to the third bar and the second bar is pivotally attached to the fourth bar. A second frame section includes a fifth bar and a sixth bar which is opposed to the fifth bar. The fifth bar is slidably engaged with the first side member of the base and the sixth bar is slidably engaged with the second side member of the base, the first frame section being adjustable from a first position to a second position such that the angle of the first bar with respect to the first side member and the angle of the second bar with respect to the second side member are adjustable while the first end edge of the first bar and the second end edge of the second bar both remain substantially disposed in a single vertical plane in the first position and in the second position.

With these embodiments, no additional clearance below the base frame is required, and the frame has a wall hugging feature. The frame may be adjusted by a single actuator, reducing cost and required power.

Other advantages, objects and/or purposes of the invention will be apparent to persons familiar with constructions of this general type upon reading the following specification and inspecting the accompanying drawings.

### BRIEF DESCRIPTION OF THE DRAWING FIGURES

FIG. 1 is a perspective view of a bed that embodies the present invention;

FIG. 2 is a perspective view of an adjustable bed frame of the bed of FIG. 1;

FIG. 3A is an elevational diagrammatic view of the adjustable bed frame of FIG. 2 in a first position;

FIG. 3B is an elevational diagrammatic view of the adjustable bed frame of FIG. 2 in a second position;

FIG. 3C is an elevational diagrammatic view of the adjustable bed frame of FIG. 2 in a third position;

FIG. 3D is an elevational diagrammatic view of the adjustable bed frame of FIG. 2 in a fourth position;

FIG. 4 is a perspective view of a second embodiment of an adjustable bed frame of the bed of FIG. 1;

FIG. 5A is an elevational diagrammatic view of the adjustable bed frame of FIG. 4 in a first position;

FIG. 5B is an elevational diagrammatic view of the adjustable bed frame of FIG. 4 in a second position;

FIG. 5C is an elevational diagrammatic view of the adjustable bed frame of FIG. 4 in a third position; and

FIG. 5D is an elevational diagrammatic view of the adjustable bed frame of FIG. 4 in a fourth position.

FIG. 6 is a partial perspective view of an adjustable bed frame with a drawer slide mechanism.

### DETAILED DESCRIPTION OF THE PREFERRED EMBODIMENTS

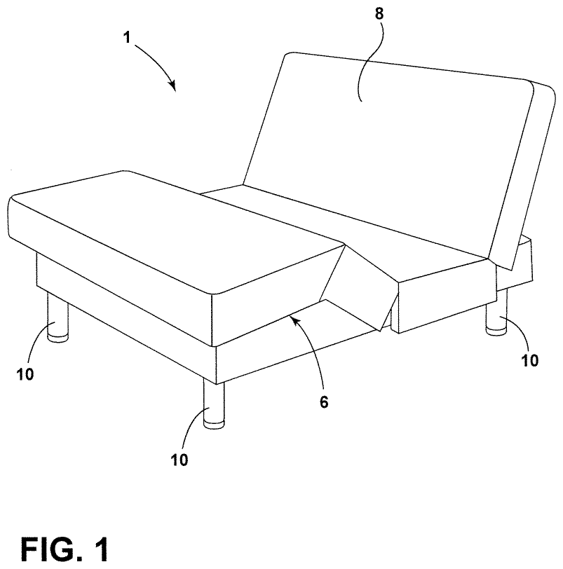

FIG. 1 depicts an adjustable bed 1. The adjustable bed 1 generally includes an adjustable bed frame 6, a mattress or other cushioned topper 8, and optionally legs 10.

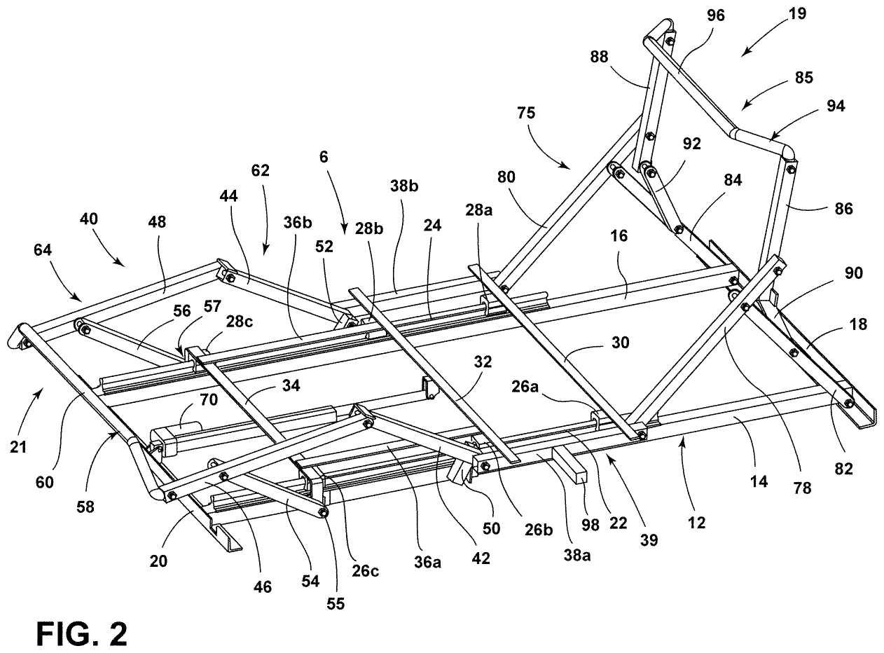

The bed frame 6, as shown in FIG. 2, has a base 12 that includes a first side frame member 14 and a second side frame member 16, which is preferably substantially parallel to the first side frame member 14. A head frame member 18 at a head end 19 is attached to both the first side frame member 14 and the second side frame member 16, and is substantially perpendicularly disposed in its longitudinal direction to both. A foot frame member 20 at a foot end 21 is also connected to both the first side frame member 14 and the second side frame member 16, and is also substantially perpendicular to both of the side frame members. The head and foot frame members 18, 20 can be any desired cross-sectional shape, such as L-shaped shown in FIG. 2, and may be attached to the side frame members 14, 16 by any means such as welding or by fasteners.

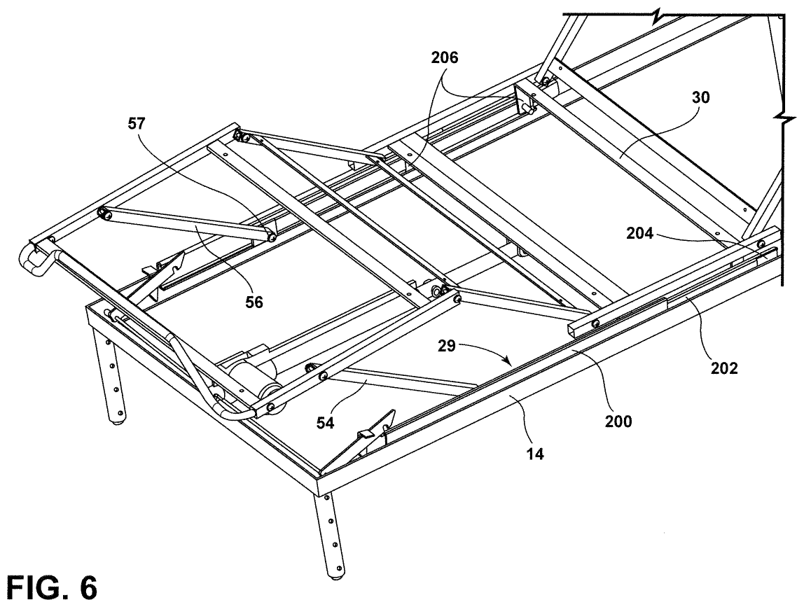

A left-side slide rail 22 and a right-side slide rail 24 are fixedly attached to first side frame member 14 and second side frame member 16, respectively. The slide rails 22, 24 are preferably attached to the upper side of the side frame members 14, 16 to allow for easier attachment and slideability for other frame components, as discussed in more detail below. Slidably engaged with slide rail 22 are left-side slider blocks 26a, 26b, 26c, and slidably engaged with slide rail 24 are right-side slider blocks 28a, 28b, 28c. Any number of slider blocks, of any reasonable size, can be employed to assist in adjustment of the frame. The slider blocks 26a, 26b, 26c are preferably evenly spaced from each other but such spacing is not critical. The slider blocks 28a, 28b, 28c are also preferably evenly spaced from each other but such spacing is not necessary. Complimentary slider blocks, for example slider blocks 26a and 28a, are preferably positioned the same with respect to each other in the longitudinal direction. Other slide mechanisms, such as a heavy duty ball bearing drawer slide mechanism 29 (see FIG. 6), may be used where the drawer slide mechanism 29 attaches to other components, as discussed below. The drawer slide mechanism 29 is employed on each side of the bed frame and includes a fixed component 200 attached to a bed frame portion such as the first side frame member 14 and which is connected to a slide intermediate member 202. The slide intermediate member 202 is connected to an inner component 204. One or more seat members 206 attach other components of the frame, such as the first cross bar 30, to the drawer slide mechanism 29. Use of a drawer slide mechanism may eliminate the need of other structural components.

Attached to each of slider blocks 26a and 28a is the first cross bar 30. Attached to each of slider blocks 26b and 28b is a second cross bar 32. Attached to each of slider blocks 26c and 28c is a third cross bar 34. The cross bars 30, 32, 34 assist in rigidity and stability of the bed frame 6, and also supply a platform upon which a mattress or other structure, or a portion thereof, can reside. Additional lengthwise braces 36a, 36b may also be employed for additional strength and stability. The frame 6 also includes opposing outer bars 38a, 38b which are generally disposed in a lengthwise direction and assist in connecting other components, discussed in detail below, to the remainder of the frame 6. The outer bars 38a, 38b, in addition to cross bars 30, 32 create a midsection 39 of the adjustable bed frame 6.

The bed frame 6 also includes a legrest portion 40. The legrest portion 40 includes a first leg member 42, a second leg member 44, a third leg member 46, and a fourth leg member 48. The first leg member 42 and the second leg member 44 oppose one another, are substantially parallel with respect to each other, and define an upper leg section 62. The third leg member 46 and the fourth leg member 48 oppose one another, are substantially parallel with respect to one another, and define a lower leg section 64. The first leg member 42 is pivotally connected to the third leg member 46, and the second leg member 44 is pivotally connected to the fourth leg member 48. The first leg member 42 is also pivotally connected to the outer channel 38a and a pivot stop member 50. The second leg member 44 is also pivotally connected to the outer channel 38b and a pivot stop member 52. The third leg member 46 is pivotally connected to a first foot segment control arm 54, which in turn is pivotally connected to the first side frame member 14 at a first connection point 55. The fourth leg member 48 is pivotally connected to a second foot segment control arm 56, which in turn is pivotally connected to the second side frame member 16 at a second connection point 57. Such a structure allows for a adjustable angle and raisable leg rest, preferably used with a bendable mattress. A retainer 58 connects the third leg member 46 and the fourth leg member 48. The retainer 58 preferably has a raised portion 60 which can be used as a handle to move the retainer 58 longitudinally for different sized mattresses and for assisting in securing a mattress to the frame. The legrest portion 40 thus has two sections, the upper leg section 62 and the lower leg section 64.

The bed frame 6 also includes a backrest portion 75. In the embodiment shown in FIG. 2, the backrest portion 75 includes two opposing back bars 78, 80 which are substantially parallel to each other and are pivotally connected to the outer channels 38a, 38b, respectively. The back bar 78 is also pivotally connected to a first brace 82, and the back bar 80 is pivotally connected to a second brace 84. The braces 82, 84 are substantially parallel to each other and are opposed to one another. The brace 82 is pivotally connected to the first side frame member 14 and the brace 84 is pivotally connected to the second side frame member 16.

In this embodiment, the backrest portion 75 is attached to a headrest 85. The headrest 85 includes opposing members 86, 88 which are substantially parallel to one another. The members 86, 88 are respectively pivotally attached to braces 82, 84 by brackets 90, 92. The brackets 90, 92 are opposed to one another and are substantially parallel to one another. The member 86 is also pivotally connected to the back bar 78, and the member 88 is pivotally connected to the back bar 80. The members 86, 88 are connected to one another by a retainer 94 which has a raised portion 96. The retainer 94 is preferably extendable with respect to the members 86, 88 and the raised portion 96 assists in adjusting the length of the frame and in retaining the head of a mattress.

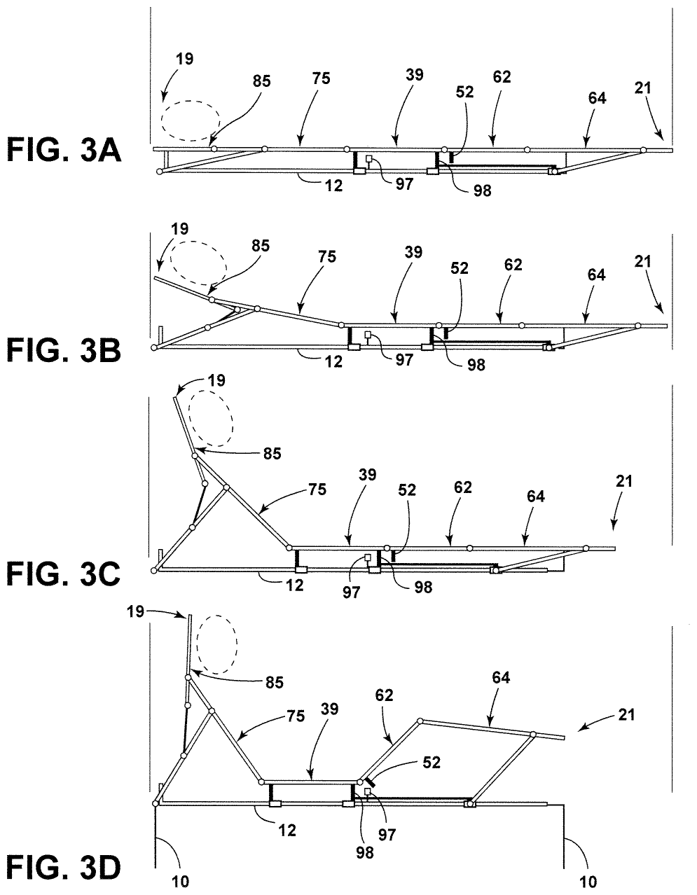

The headrest 85 is adjustable with respect to the backrest portion 75, preferably from 0° to 60° with respect to the backrest portion 75, resulting in a 5-section variant. These five sections, comprising an upper frame section, are the headrest 85, the backrest 75, the midsection 39, the upper leg section 62, and the lower leg section 64. FIGS. 3A, 3B, 3C, and 3D show some of the variations in which the 5-section variant of the present embodiment can be employed.

A single actuator 98, such as a low-capacity actuator or a manual actuator is used to adjust the entirety of the upper frame portion, among the positions shown in FIGS. 3A-3D. The actuator 98 may be, and is preferably, positioned toward the leg end of the bed frame, resulting in increased noise comfort for the user. The actuator 98 may be moved linearly, substantially in the longitudinal direction, to adjust the upper frame portion.

A biasing mechanism 70, such as a hydraulic cylinder, is attached to the stationary portion of the bed frame 6 at the foot frame member 20, as well as the movable portion of the bed frame 6 at the cross bar 32. The biasing mechanism 70 allows for a stable adjustment mechanism by dampening the movement of the upper frame portion of the bed frame 6.

The position of FIG. 3A is the flat or sleeping position. When the actuator 98 is actuated while the bed frame 6 is in flat position, the slide blocks 26, 28, or other slidable member of the slide mechanism, are moved toward the head end 19 of the bed frame 6. This results in various parts in the upper frame portion of the bed frame 6 being moved. Specifically, the lower leg portion 64, the upper leg portion 62, and the midsection 39 are moved in the longitudinal direction toward the head end 19 of the bed frame 6. Actuation of the actuator 98 also moves the backrest portion 75 at an angle upward with respect to the midsection 39, and with respect to the lower leg portion 64 and the upper leg portion 62. The headrest 85 is moved at an angle even further upward. This is the position shown in FIG. 3B, which is an anti-snore and anti-GERD position. Further actuation of the actuator 98 will result in the further movement of the midsection 39, the lower leg portion 64, and the upper leg portion 62 in the longitudinal direction toward the head end 19. The backrest portion 75 and the headrest 85 move at a further angle with respect to the other sections, and with respect to each other. This is the position shown in FIG. 3C, the so-called “Fowler's position,” which provides a more upright position with the backrest portion 75 being at approximately 45° with respect to the midsection 39. Yet further actuation of the actuator 98 results in further longitudinal movement of the upper frame portion of the bed frame 6 toward the head end 19. This results in ever further movement at an upward angle of the backrest portion 75 and the headrest 85, with the headrest 85 being approximately 90° with respect to the midsection 39. The midsection 39 remains substantially horizontal with respect to the ground and substantially parallel with respect to the base 12. During the longitudinal movement of the upper frame portion of the bed frame 6, the pivot members 50, 52 each engage a stop 97 during the last 10° of backrest motion. Such engagement results in the upper leg portion 62 being angled upwardly with respect to the midsection 39 and the lower leg portion 64 being raised and angled slightly downwardly with respect to the midsection 39, as shown in FIG. 3D. The position shown in FIG. 3D is referred to as the “zero gravity” position, wherein the backrest 75 is preferably at approximately 55° with respect to the midsection 39, and the lower leg portion 64 is raised. A pair of latches may be used to have “early” and “late” leg rise positions.

The structure of the bed frame 6 shown in FIGS. 2 and 3A-3D results in a wall hugging device at the head end 19 that is suited for a number of situations, including tight space areas such as RVs and small bedrooms.

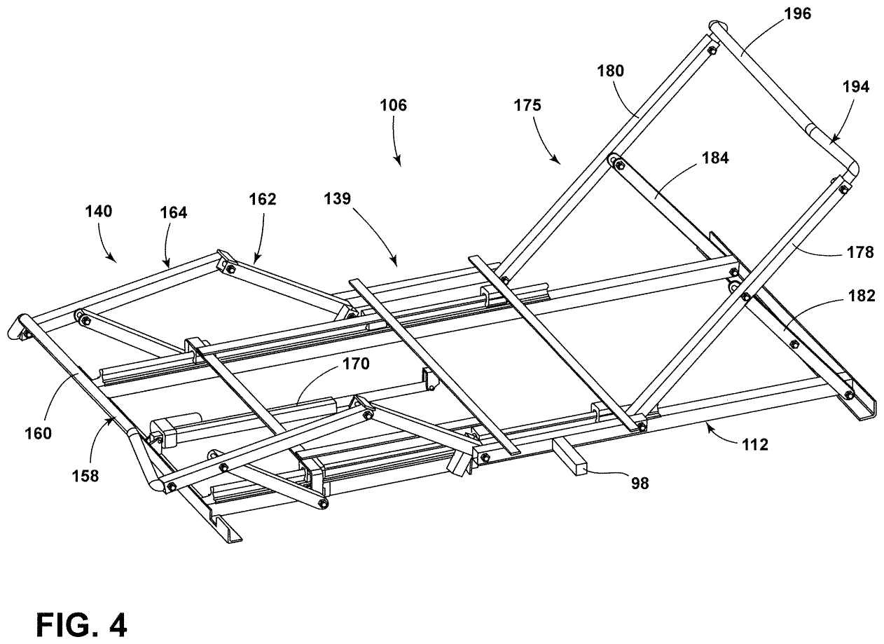

The reference 106 (FIG. 4) generally designates another embodiment of the present invention, being an adjustable bed frame. Since adjustable bed frame 106 is similar to the previously described adjustable bed frame 6, similar parts appearing in FIGS. 1-3 are represented by the same, corresponding reference number except for the addition of 100 added to the reference number. The adjustable bed frame 106 is a 4-section variant, including the sections of a back/headrest 175, a midsection 139, an upper leg section 162, and a lower leg section 164. The difference between this embodiment and the adjustable bed frame 6 is that the adjustable bed frame 106 has no adjustable headrest. In that regard, with respect to the backrest 75 and headrest 85 of the first embodiment, the back bars 178, 180 are longer and there are no pivotally connected members to create an adjustable headrest. Instead, the back bars 178, 180 are connected to one another by a retainer 194 which has a raised portion 196 for retaining the head portion of a mattress. The back bars 178, 180 are opposed and substantially parallel to one another and are pivotally connected to the base 112 directly and via braces 182, 184 respectively.

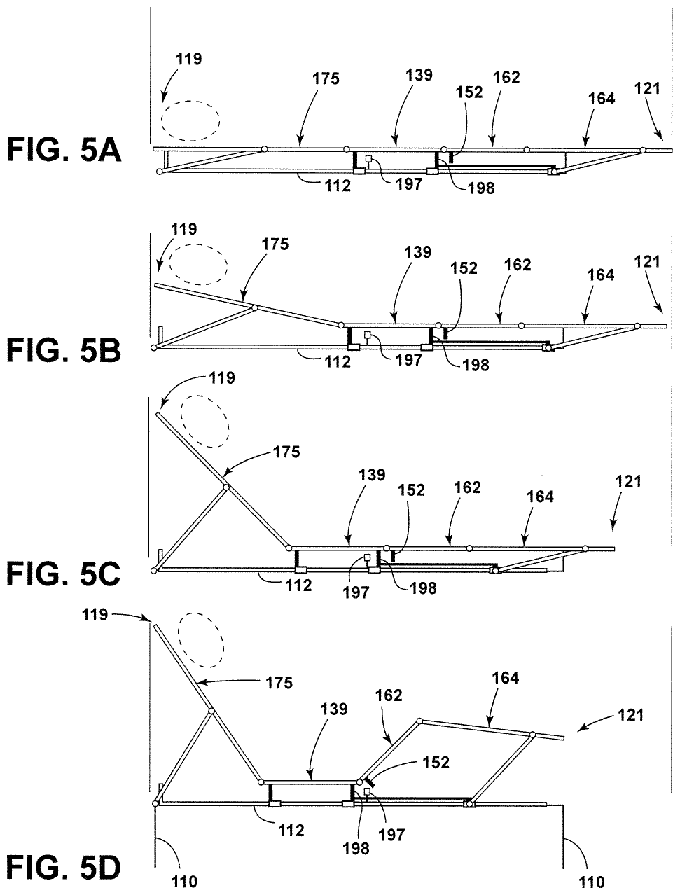

FIGS. 5A, 5B, 5C, and 5D show some of the variations in which the 4-section variant of the present embodiment can be used. A single actuator 198, such as a low-capacity actuator, is used to adjust the entirety of the upper frame portion, among the positions shown in FIGS. 5A-5D. The structure of the bed frame 106 shown in FIGS. 4 and 5 results in a wall hugging device that is suited for a number of situations.

The operation of the bed frame 106 is substantially the same as that for bed frame 6, but without a separate adjustable headrest. The position of FIG. 5A is the flat or sleeping position. When the actuator 198 is actuated while the upper frame portion of the bed frame 106 is in flat position of FIG. 5A, the slide blocks or other slidable member of the slide mechanism are moved toward the head end of the bed frame 106. As a result, the lower leg portion 164, the upper leg portion 162, and the midsection 139 are moved in the longitudinal direction toward the head end of the bed frame 106. The movement also moves the backrest portion 175 at an angle upward with respect to the midsection 139, the lower leg portion 164, and the upper leg portion 162. This is the position shown in FIG. 5B, which is an anti-snore and anti-GERD position. Further actuation of the actuator 198 results in the further movement of the midsection 139, the lower leg portion 164, and the upper leg portion 162 in the longitudinal direction toward the head end. The backrest portion 175 moves at a further angle with respect to the other sections. This is the position shown in FIG. 5C, the so-called “Fowler's position.” Yet further actuation of the actuator 198 causes further longitudinal movement of the upper frame portion of the bed frame 106 toward the head end. This results in ever further movement at an upward angle of the backrest portion 175. The midsection 39 remains substantially horizontal with respect to the ground and substantially parallel with respect to the base 112. During the longitudinal movement of the upper portion of the bed frame 106, the pivot members 150, 152 each engage a stop 197 during the last 10° of backrest motion. Such engagement results in the upper leg portion 162 being angled upwardly with respect to the midsection 139 and the lower leg portion 64 being raised and angled slightly downwardly with respect to the midsection 139, as shown in FIG. 5D, the “zero gravity” position. The backrest 175 is at approximately 55° with respect to the midsection 39, and the lower leg portion 164 is raised.

Other embodiments, such as a 3-section variant with only a midsection, a back/headrest section, and a single leg rest section, are contemplated. Various widths of frames, such as between 30″ and 38″, which can be used in multiples to create the proper width of standard mattress sizes, may be employed.

The design of the adjustable bed frame described herein allows an easy-to-use, low profile adjustable bed frame that is suitable for tight spaces. The adjustability by a single actuator and the structure resulting in a wall hugging feature at the head of the bed is an improvement and a novel device that is desired in many markets, including the RV market. Protrusions below the base are not required and the foot end retracts when actuated to allow another access to the space below and at the end of the bed.

1. An adjustable bed frame comprising:
a base;
a slide mechanism connected to the base;
a first frame section;
a second frame section pivotally attached to the first frame section via at least one pivot link, and having a head end edge;
a third frame section pivotally attached to the first frame section and having a foot end edge which is spaced from the head end edge in the longitudinal direction,
wherein the first frame section is engaged with the slide mechanism to allow sliding of the first frame section with respect to the base, the second frame section being adjustable from a first position to a second position such that the angle of the second frame section with respect to the first frame section is adjustable while the head end edge remains substantially disposed in a single vertical plane in the first position and in the second position.

2. The adjustable bed frame of claim 1, and further including an actuator for adjusting the adjustable bed frame from the first position to the section position.

3. The adjustable bed frame of claim 2, wherein the actuator is the only actuator.

4. The adjustable bed frame of claim 1, and further including a fourth frame section connected to the third frame section and which is pivotal with respect thereto and is configured to be raised with respect to the base.

5. An adjustable bed frame comprising:
a base having a first side member and a second side member;
a first slide mechanism connected to the first side member of the base;
a second slide mechanism connected to the second side member of the base;
a first frame section including a first bar with a first end edge, a second bar with a second end edge, and third bar, and a fourth bar, the first bar and the second bar being parallel to each other and the third bar and the fourth bar being parallel to each other, the first bar being pivotally attached to the third bar and the second bar being pivotally attached to the fourth bar;
a second frame section including a fifth bar and a sixth bar which is opposed to the fifth bar,
wherein the fifth bar is slidably engaged with the first side member of the base via the first slide mechanism and the sixth bar is slidably engaged with the second side member of the base via the second slide mechanism, the first frame section being adjustable from a first position to a second position such that the angle of the first bar with respect to the first side member and the angle of the second bar with respect to the second side member are adjustable while the first end edge of the first bar and the second end edge of the second bar both remain substantially disposed in a single vertical plane in the first position and in the second position.

6. The adjustable bed frame of claim 5, and further including an actuator for adjusting the adjustable bed frame.

7. The adjustable bed frame of claim 6, wherein the actuator is the only actuator.

8. The adjustable bed frame of claim 5, and further comprising a third frame section pivotally connected to the second frame section.

9. The adjustable bed frame of claim 8, and further comprising a headrest section which is pivotally connected to and adjustable with respect to the first frame section.
